(19) United States
(12) Patent Application Publication
(10) Pub. No.: US 2002/0080753 A1
(43) Pub. Date: Jun. 27, 2002

(54) Embedded commerce channel in a wireless network

(76) Inventor: Steven K. Lee, Minneapolis, MN (US)

Correspondence Address: Daniel A. Tysver, Beck & Tysver, Suite 440, 1011 First Street South, Hopkins, MN, 55343, US

(21) Appl. No.: 09/746,817

(22) Filed: Dec. 22, 2000

(51) Int. Cl. H04Q 7/24

(52) U.S. Cl. 370/338; 370/401

(57) ABSTRACT

A method and apparatus is presented for burying a commerce data stream into a network data stream. In the preferred embodiment, the network data stream is an MPEG-2 type video data stream, and the commerce data stream is embedded so that it is neither readily detectable nor easily removable from the network data stream. A home gateway having a wireless transceiver communicates with appliances in the home via this MPEG-2 type video data stream. Non-video data to be transmitted to the appliances is encapsulated in a video data stream, such that the commerce data stream can be buried using the same technique used with video data. The commerce data stream can be embedded with the network data stream either by the content provider, or by the gateway itself at the home. Appliances in the home receive the data stream with the embedded commerce data. At that point, the commerce stream can be removed from the digital data, and is presented to the user in a way appropriate for the appliance. Instructions as to how the commerce stream is to be presented on the appliance can be embedded into the commerce stream itself.

### FIELD OF THE INVENTION

The present invention relates generally to the use of an embedded communication channel within a digital communication stream. More specifically, the present invention relates to an embedded channel used for the delivery of commerce messages within a wireless home network.

### BACKGROUND OF THE INVENTION

For many years, advertising has served as one of the primary financial supports for the development of new media formats. Before the advent of cable television and pay-per-view events, commercial advertisements allowed television services to be provided to the consuming public without charge. The ability to present commercial messages to the public has also supported free radio services, and has greatly reduced the consumer cost of newspapers and magazines.

With the advent of the Internet and the World Wide Web, many attempts have been made to establish a method for effectively presenting commercial messages to Internet users. Banner ads on web site became a ubiquitous part of the Internet within three years of the invention of the graphical web browser. In the beginning, banner ads were considered an effective means of sending commercial messages to Internet users. For instance, much of the initial user base of Amazon.com was attracted by banner ads that seemingly appeared on every commercial web site.

However, as the Internet aged and “click-throughs” on banner ads diminished, advertisers became disenchanted with the ability of banner ads to reach consumers. Advertising rates for banner ads decreased, and advertisers began searching for other ways to reach Internet consumers. Variations on banners ads soon developed, including “pop-up” advertisements that appeared in their own window when a web page was accessed. Some users, many of whom were comfortable with banner ads, considered the pop-up ads to be too intrusive. Thus, pop-up advertisements are not currently a popular method of Internet advertising. Advertisers are therefore left searching for another method of reaching Internet users through the limited capabilities of the World Wide Web interface.

Both pop-up advertisements and banner ads are generally ordered from web site content providers or their agents. When users request pages from a web site, the site selects an advertisement and presents it to the users. Fees are usually paid to the web site either on a per view or a per click-through basis. Thus, advertisements placed with the web site are valuable only to the extent that users are attracted to the web site. The most valuable sites to advertisers tend to be “portal” web sites, which attract users with a wide array of useful content. Some portal web sites are directly associated with Internet access providers, which allows them to be assigned as the default home pages for users of the access providers.

Unfortunately, advertisements placed via a web site content provider have not been as successful as advertisements in the more traditional media of radio and television. This is most likely due to several concurrent factors. First, there is the customer reaction of ignoring banner ads while simultaneously objecting to pop-up web advertisements. Since advertisements placed on web sites must be transmitted via HTML, Java, or a related language, advertisers are currently left searching for an innovative way to use these languages to reach consumers.

Second, with advertisements placed on a web site, there is no guarantee that the advertisement will be successfully transmitted to the user. Intermediaries between the web site content provider and the end user are in control of the data stream. Internet access providers could use their control of the pipeline to alter or replace advertisement. In addition, Internet users can use sophisticated programs to screen out unwanted advertisements.

Third, there is very little ability to reach a large audience with a single advertising campaign. While Internet portal sites reach larger audiences than other sites, sophisticated uses will change home pages to meet their needs. Thus, even the largest portal sites have been faced with significantly decreased advertising revenue.

Finally, since the web site advertisement paradigm presumes that users will be using the Internet to access an actual web site, these advertisement are not able to be associated with other types of Internet usage. For instance, users that download music files or streams may not even use a web site as an interface to such files. Alternatively, future televisions may directly access video programs through the Internet without first accessing a traditional web page. Users of such technology would therefore not be potential audiences for a web site advertisement. Thus, as more digital content becomes available over the Internet, web site advertisements will become less and less relevant.

Another avenue for presenting advertisements to Internet users is to coordinate the advertisements through the hardware used to interact with the Internet. For instance, several companies have offered free or reduced price computer hardware in exchange for the right to present tailored advertisements to the user. The users agree to provide demographic information about themselves, which allows the hardware providers to sell tailored ads to advertisers at a higher ad rate. Unfortunately, since the advertising stream to the hardware was neither particularly secure nor particularly well integrated with the web sites being viewed, programs were created which “hacked” the hardware and eliminated the advertisements on users' screens.

What is needed then is a new method of linking commercial advertising messages to Internet content. This method should not be dependent on the existence of a web page, and should allow commercial messages to be linked directly to content, either at the source or at the user's location.

### SUMMARY OF THE INVENTION

The present invention meets these needs by providing a commerce data stream that is embedded into a network data stream. This data stream can be embedded into a wireless local area network, in which data streams can be transferred from data sources to end user appliances within a home.

In one embodiment of the present invention, the commerce data stream is deeply embedded at a source of digital data. This commerce stream is undetectable until the digital data is decoded in order to be accessed by the end user. At that point, the commerce stream can be removed from the digital data, and can be presented to the user in a way that is appropriate for the digital data.

Video material could be transmitted from its source in an MPEG format or future variants of such a format. Within MPEG encoded data could be a hidden or buried commerce data stream. This hidden stream would not be detectable by any of the entities that control the data stream, including Internet access providers or home broadband entry points. When the data stream enters the home, it would be disseminated through a wireless local area network. A wireless transceiver port on a home appliance would receive that signal. This port would decode the MPEG transmission as appropriate for the appliance, such as into a HDTV signal for a HDTV set. The port would also be able to decode the buried commerce channel. The data in this commerce channel would allow commercial message to then be shared with a user in the manner desired and selected by the advertiser. For instance, a TV like commercial could interrupt the normal MPEG signal. Alternatively, a pop-up advertisement could appear on the screen, or an area of the screen could be reserved for advertisements. Of course, the buried commerce channel should not significantly alter the transmitted data, so that appliances that are incapable of decoding the commerce signal could still present the entire MPEG signal without any significant signal degradation.

In a second embodiment, a gateway with a broad band communication path to the Internet is provided in the home environment. The gateway further acts as a wireless LAN transceiver, or base station. The gateway has access to a source of commercial messages. The gateway then embeds the commercial messages in a buried commerce data pathway hidden within the wireless communication to appliances in the home. A receiver on an appliance receives this wireless communication, and decodes the communication into a regular data path, which contains data received over the Internet through the gateway, and a commerce data path, which includes the commercial messages. The commercial messages are then presented to the user via the appliance in a manner appropriate to the appliance.

In a third embodiment of the present invention, commercial messages on the commerce data paths of embodiment one and two are sold to advertisers. Revenue from the advertising sales are utilized to reduce the cost of the wireless network components.

### BRIEF DESCRIPTION OF THE DRAWINGS

FIG. 1 is a schematic illustration of a prior art home network utilizing a prior art gateway and a media server.

FIG. 2 is a schematic illustration of a home network using a gateway of the present invention.

FIG. 3 is a schematic illustration of a network and the related data streams used to obtain video source material over the Internet for playback on a television, where a commercial message is embedded by the content provider.

FIG. 4 is a schematic illustration of a network and the related data streams used to obtain video source material over the Internet for playback on a television, where a commercial message is embedded by the gateway of the present invention.

FIG. 5 is a schematic illustration of a network and the related data streams used to obtain HTML web page data over the Internet for playback on an Internet appliance, where a commercial message is embedded by the gateway of the present invention.

FIG. 6 is a flow chart of a methodology of the present invention using advertising revenue to subsidize the cost of the gateway and adapters used in the present invention.

### DETAILED DESCRIPTION OF PREFERRED EMBODIMENTS

Preferred Wireless Data Protocol and Data Burying Capability

The present invention requires the use of wireless protocols and data burying techniques, as will be described in more detail below. These basic technologies exist in the prior art, and do not form part of the present invention. Consequently, the details of these technologies will not be described. However, the method of combining these technologies and the use to which the technologies are placed do form a part of the present invention, and will be described in detail below.

It is preferred that the wireless protocol used by the present invention be a high bandwidth protocol capable of supporting multiple channels at least as wide as the 20 Mbps required by an HDTV channel. Although several developers have proposed specifications for such a wireless protocol, the preferred protocol for the present invention is the G2, or “Gigatoo,” protocol developed by Sarnoff Corporation (Princeton, N.J.). This protocol, which should be commercially available in the year 2001, provides for 50 separate 40 Mbps channels, for a total capacity of 2 Gbps. The protocol uses confidential, patent pending technologies to provide this wireless bandwidth, including the use of multiple antennas to combat multi-path distortion.

The G2 protocol operates in the Unlicensed National Information Infrastructure (U-NII) bands assigned in the 5.6 GHz region. The total U-NII bandwidth available in the region is 300 MHz. Since a single G2 channel operates within a 6 MHz bandwidth, up to 50 G2 two-way wireless channels can operate concurrently.

The G2 protocol includes compensation for Doppler distortions of up to 80 Hz. This allows for the use of the G2 protocol with hand-held devices that are moved within the wireless coverage area during usage. The G2 protocol also allows the use of low power levels, which makes battery operated use feasible.

The data burying technique used in the present invention is basically a method for combining two channels or data streams together into a single data stream. Numerous techniques presently exist for achieving this result, including basic frequency and time-division multiplexing techniques. Basic multiplexing techniques are not preferred, however, since they are easily detectable. Once detected, it is relatively easy to filter out one of the combined data streams if the stream is undesired. Consequently, the present invention utilizes a technique for burying a data stream within another data stream in a manner that is not easily detected.

Sarnoff Corporation has developed one such technique. The Sarnoff data burying technique works, in part, by taking advantage of the redundantly coded syntax element values in MPEG and MPECG-like bitstreams. MPEG-like bitstreams are bitstream definitions accepted by basic industry groups for the compression, coding, and digital transmission of audio and visual data. In the MPEG-2 bitstream definition, one of the coded syntax element values is overriding. The Sarnoff technique includes mandatorily coding the syntax element overriding value and replacing the non-overriding syntax element value with the data to be buried. This technique is particularly useful for the present invention since it does not noticeably corrupt or otherwise alter the general usability of the main content of the MPEG bitstream. The Sarnoff techniques allow the creation of a 90 Mbps buried data stream within a 2 Gbps MPEG-2 stream. This data burying technique also uses confidential, patent pending technologies.

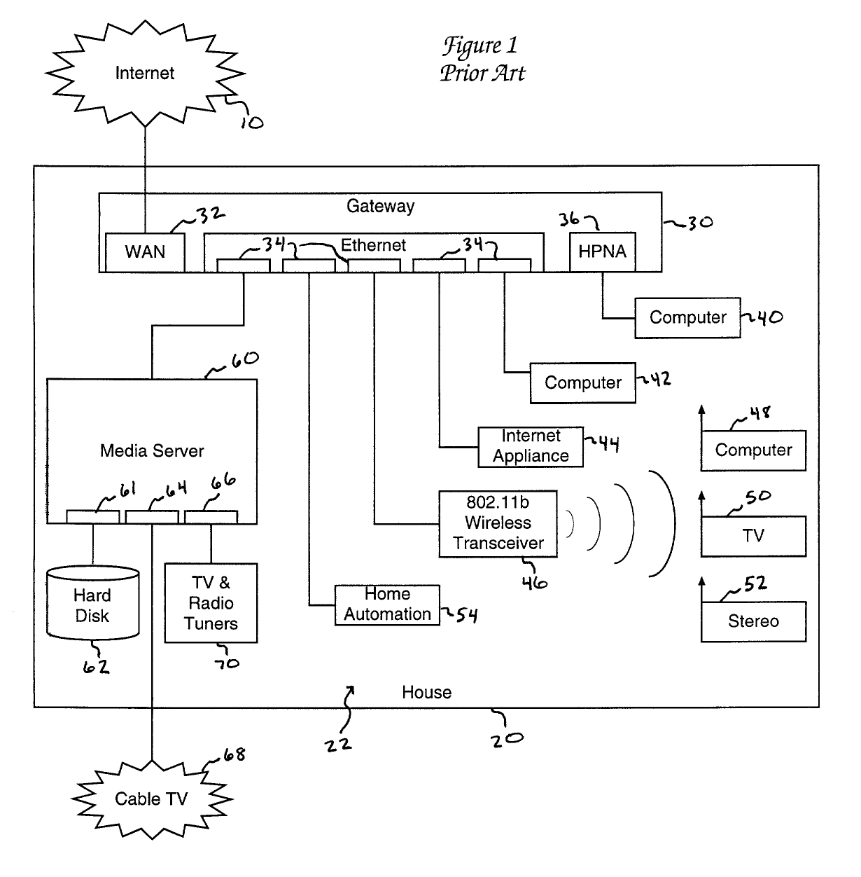

Although the present invention will be described below using the G2 wireless technology and the Sarnoff data burying techniques, other techniques could be used without exceeding the scope of the present invention. For instance, any wireless technology with sufficient bandwidth to transfer high definition video signals could be utilized in place of the G2 technology. In addition, other techniques for burying or otherwise combining data streams could be utilized to merge the commerce data stream with a requested content data stream. This, of course, does not mean that the combination of the G2 wireless technology and the Sarnoff data burying technique in the way described below does not create an unexpected, synergistic result. Prior Art Home Network As an understanding of the basic technology and functionality of a home network is important to an understanding the present invention, this detailed description of the invention begins with a description of the prior art. FIG. 1 shows an example of access to the Internet 10 for a house 20 using an Internet gateway 30, such as is already contemplated in the prior art. This prior art gateway 30 serves as the primary linkage between appliances in the house 10 and the Internet 10. The gateway 30 has a WAN interface 32, such as an ADSL interface, multiple Ethernet ports 34, and other access ports such as a Home Phone Networking Alliance (HPNA) interface 36. The HPNA interface 36 follows the HPNA architecture to allow networking to a computer 40 through the existing home phone wiring. Similar proposed technologies include networks of home appliances communicating through the existing power lines already in the home.

Ethernet ports 34 can be used to connect a variety of standard computing devices such as computer 42 and Internet appliance 44 to the Internet 10. Such use of a gateway 30 to share Internet access to a variety of devices 40, 42, 44 is well established in the prior art.

It is also possible to connect a wireless LAN transceiver or base station 46 to one of the Ethernet ports 34 of the gateway 30. Such a wireless transceiver 46 allows the creation of an 11 Mbps wireless network according to IEEE standard 802.11b. Such a network can be accessed by any device with a receiver or transceiver abiding by the 802.11b standard, such as computer 48. Others have envisioned the incorporation of a 802.11b transceiver in a television set 50. This would allow Internet access from the TV 50, and perhaps even allow the TV 50 to play compressed video signals that are stored on either a computer 40 or 42, or are received from the Internet 10. Similar technology could be used to connect home stereo equipment 52 to the wireless base station 46.

It is also possible to connect home automation equipment 54 to the gateway 30. Such equipment 54 could include home security devices, which could access a security service through the Internet 10 or through the standard phone service (not shown in FIG. 1). Equipment 54 could also include controllers that can be used to control the environment in house 20. Such controllers could control lights, heating, and even automated doors and windows. Access could be provided to and from the home automation equipment 54 to external service providers and utilities through the Internet 10.

The concept of a media server 60 is also well established in the prior art. Media servers such as server 60 are generally responsible for the storage and direction of audio and visual materials in a home network. As shown in FIG. 1, a media server 60 could have Internet access through an Ethernet port 34 in gateway 30. Media servers 60 generally include a port 61 for connection to a large hard disk 62, upon which could be stored digitally encoded audio/video materials. Alternatively, the hard disk 62 could be incorporated into the media server 60, or other storage media could be used to replace the hard disk 62. Media servers 60 will also have input ports 64, 66, such as an input 64 for traditional cable television 68, or input 66 for traditional television or radio tuners 70. Similar input ports for satellite television, DVD players and recorders, VCRs, camcorders, and digital cameras are also well established parts of media server concept.

The gateway 30, media server 60, and the other components shown in the house 20 in FIG. 1 are generally considered to form a home network 22.

Preferred Gateway including Media Server Capabilities

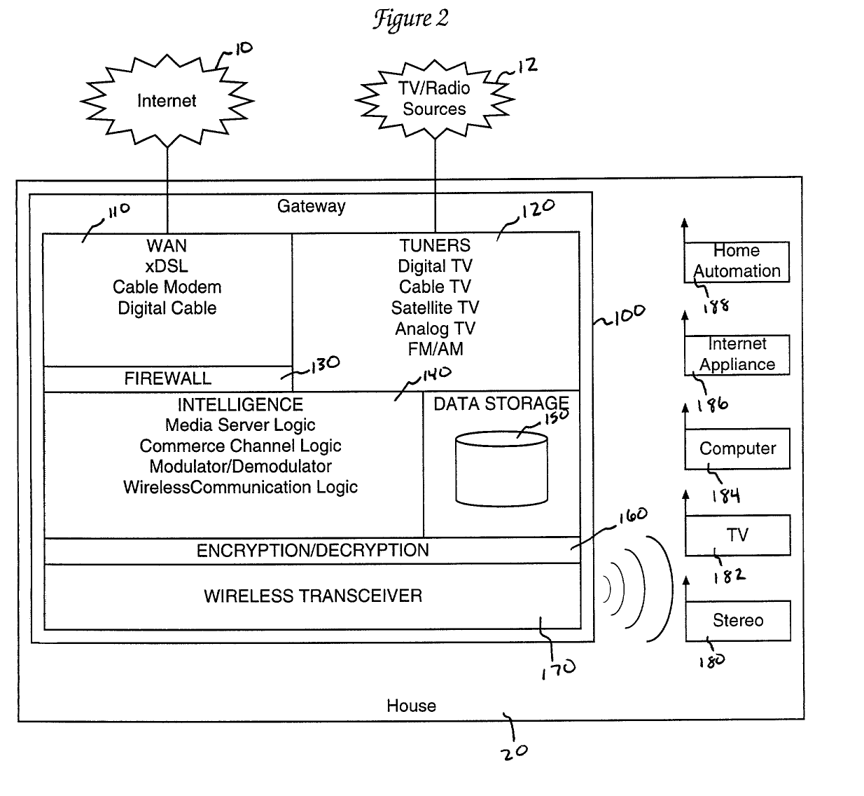

FIG. 2 shows a gateway 100 of the present invention. This gateway 100 combines the functionality of the gateway 30, media server 60, hard disk 62, and the wireless transceiver 46 of prior art FIG. 1. Although it is contemplated that these capabilities all exist within the box enclosing the gateway 100, it would be obvious to those skilled in the art that some of these functions could be moved to external components without altering the inventive concept.

The gateway 100 functions to provide access to the Internet 10 and external television and radio sources 12 to various appliances 180-188 in the house 20. In this description, the coverage area of the wireless local area network will be referred to as the house 20, even though the present invention has applicability to all areas where sponsors would be interested in sending commercial messages to individuals download digital data.

In FIG. 2, the appliances 180-188 are shown as a stereo 180, a television 182, a computer 184, an Internet appliance 186, and home automation equipment 188. These appliances 180-188 are representative only, and variations in the number, function, and variety of these appliances 180-188 are well within the scope of the present invention.

The gateway 100 has a WAN interface section 110 to connect to the Internet 10. This WAN interface is ideally able to manage two-way interfaces with xDSL lines and two-way digital cables. Preferably, WAN interface section 110 is able to manage multiple levels of concurrent services with a single xDSL or digital cable connection. The preferred WAN interface section 110 utilizes a Reconfigurable System on a Chip (RsoC), which provides a blend of reconfigurable and fixed functions that process transport protocols for voice, audio, videoconferencing, or video multimedia services on one DSL line. For instance, the WAN interface section 110 allows a single xDSL line to be used to handle streaming video and web access concurrently.

To interface with analog and digital television and radio sources 12, the gateway also includes a tuner section 120. This tuner section 120 contains tuner functionality to receive television signals from digital cable, digital broadcasts, satellite television, and even analog television and radio broadcast signals. In addition to receiving these signals, the preferred embodiment of the tuner section 120 includes tuners to select and receive a single channel from these sources 12. In order to allow simultaneous viewing of multiple channels from sources 12, it is necessary to include multiple tuners in the tuner section 120. Ideally, the gateway 100 will include one television tuner in the tuner section 120 for each television 182 in the house 20.

Although the preferred tuner section 120 includes the capability to decode channels from all of the sources 12 described above, it would be well within the scope of the present invention to exclude some of these capabilities. For instance, some may wish to develop a tuner section 120 without radio signal capabilities, or without the capability to receive analog signals at all. In addition, it would be well within the scope of the present invention to include tuners for different sources of audio/video signals. Such reduced or increased functionality does not materially alter the present invention.

The preferred embodiment of gateway 100 also includes a firewall section 130. Firewall section 130 protects the house environment against undesired electronic intrusion through the WAN interface section 110, which is especially important when always-on xDSL and cable modem technologies are used for Internet access.

The intelligence 140 and data storage 150 sections contain the logic and storage necessary to allow the present invention gateway 100 to operate. One of the functions handled by these sections 140, 150 is the ability of the gateway 100 to contain the utility provided by the media server 60 and hard disk 62 described above in connection with FIG. 1. For instance, it is necessary for the gateway 100 to receive user signals that select the source and channel of video programming desired. The interpretation of such signals, and sending of requested programming is handled in section 140. In addition, it is usually necessary to decode (or demodulate) the signals stored in the data storage section 150 or received via tuner section 120. Once the signals are decoded, section 140 then must encode (or modulate) the signals in the format expected by the wireless receivers in appliances 180-188. For example, the preferred embodiment transmits all signals across transceiver 170 in MPEG-2 video bitstreams. Thus, analog television signals received from tuner section 120 must be decoded from the analog signal, and then encoded into an MPEG-2 bitstream. In this way, all analog TV signals are converted to digital, MPEG-2 bitstreams by the gateway 100.

In addition, the intelligence section 140 supports multiple protocols at the MAC layer, including video, DVD, IP, Ethernet networking, and Bluetooth protocols. This allows a wide variety of appliances 180-188 and other computing devices to be used with the gateway 100.

The intelligence section 140 can also include various technologies that improve the performance or usefulness of the tuners in tuner section 120. For instance, analog television signals are often infected with various artifacts. A COMB filter can be included in intelligence section 140 to filter out some of these artifacts before the television signal is sent to one or more of the appliances 180-188.

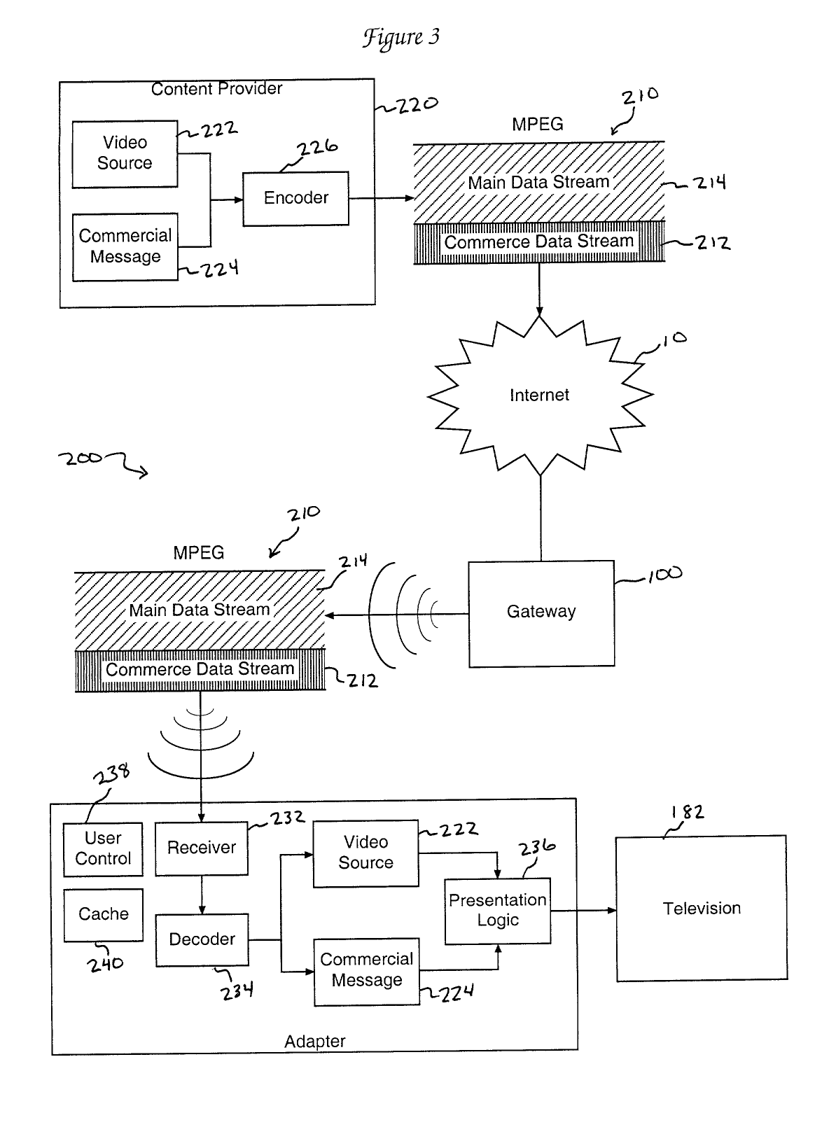

Finally, this section 140 also contains the logic necessary to encode the commerce channel within the house 20. The commerce channel, and the logic associated with it, is described in more detail below in connection with FIGS. 3 through 5.

Encryption/decryption section 160 ensures privacy for the wireless network in the house 20. This section 160 automatically encrypts data meant for appliances 180-188, and decrypts data received from the appliances 180-188. This helps maintain privacy and security for networks in neighborhoods where the reach of the wireless transceiver 170 and the appliances 180-188 extends beyond the boundaries of house 20.

Wireless transmitter 170 is responsible for the transmission of data to appliances 180-188, and for receiving data from the appliances 180-188. It is possible to use the IEEE 802.11b standard for the wireless transceiver 170, although the preferred embodiment uses the higher bandwidth G2 system as described above. The use of a higher bandwidth allows the allocation of separate channels to each of the appliances 180-188 within the house. For instance, the preferred G2 system has the capacity to handle fifty separate channels, with each channel carrying up to 40 Mbps, for a total capacity of 2 Gbps. Since 20 Mbps is the necessary capacity to carry an HDTV signal, this channel capacity allows each channel to carry two full HDTV signals. The use of fifty channels also allows the appliances 180-188 the ability to negotiate with the transceiver 170 for a clear channel using a carrier sense technique similar to that used by cordless phones. The ability to negotiate allows multiple transceivers 170 to operate simultaneously within each other's range (such as in neighboring houses).

The appliances 180-188 each contain or otherwise utilize equipment that can transmit to and receive signals from the transceiver 170. This equipment must also be capable of receiving instructions from users and encoding such instructions for use by the intelligence section 140 of gateway 100. Finally, this equipment must be capable of converting the data received from the gateway 100 into data that can be handled by the appliance 180-188. For instance, MPEG-2 video streams containing a television picture must be decoded by the equipment and presented to the television 182 as the analog or digital audio/video signals normally expected by that television 182. Initially, it is likely that this equipment will take the form of an adapter physically separate from the appliance 180-188. The adapter would incorporate the antenna(s) necessary to communicate with the gateway 100, and would further include an input device such as a remote control, keyboard, or a mouse. Eventually, it is likely that appliances 180-188 would incorporate the adapter within the appliance 180-188 itself.

The Commerce Channel

FIG. 3 shows a representative network configuration 200 utilizing the present invention. In this Figure, gateway 100 is being utilized by television 182 to obtain a video signal 210 over the Internet 10. The video signal 210 in this case is received via an MPEG-2 encoded video stream 210. A content provider 220 is the provider of the video source material 222 in video signal 210. Using the present invention, the content provider 210 is able to combine a commercial message 224 with the video source material 222, and be assured that the commercial message 224 will remain with the source material 222 all the way to the end user. In the present description, the term commercial message 224 will be used to refer to all messages for which a sponsor is will to pay in order to disseminate the message to others who would not otherwise seek out that message. Thus, the term commercial message 224 would cover product and service advertisements, religious and political messages, public service type messages, and other messages of this type.

This is accomplished by using an encoder 226 which utilizes a data burying technique to combine a commerce data stream 212 with a main data stream 214 within a single data stream 210. In the preferred embodiment, this is accomplished using technology developed by Sarnoff Corporation, as described above. The resulting data stream 210 is an MPEG-2 encoded video signal. The commerce data stream 212 has been embedded in the stream 210 in what had been the redundantly coded syntax element values normally found in the MPEG bitstreams. Using the Sarnoff technique, the main data stream portion 214 of the MPEG stream 210 is unaffected, and therefore contains the whole of the video source material 222 originally provided by the content provider 220.

One of the primary benefits of the Sarnoff data burying technique is that the commerce data stream 212 embedded in the MPEG-2 stream 210 does not alter the overall usability of the stream 210. Thus, the same data stream 210 could be received by an MPEG-2 capable appliance, and the video source 222 found in the main data stream 214 could be played unaffected by the presence of the buried commerce data stream 212. This is true even if the receiving MPEG-2 appliance receiving the signal 210 was unaware of the presence of the commerce data stream 212.

Another benefit of the Sarnoff data burying technique is that the commerce data stream 212 is not easily detected and removed. As a result, it is possible to link the commerce data stream 212 with main data stream 214 with a strong assurance that no intermediaries will detect and remove the commerce data stream 212. In addition, the way in which the commerce data stream 212 is buried in the MPEG-2 stream 210 ensures that the commerce stream 212 will survive subsequent re-multiplexing as long as the video itself is not decoded to pixels.

In addition, the way the two streams 212, 214 exist simultaneously in the MPEG-2 stream makes it extremely easy to synchronize the two streams 212, 214 together. As a result, the content provider 220 can design the commercial message 224 with confidence that the message 224 will appear to the user at the correct moment during review of the video source 222.

In the case shown in FIG. 3, the MPEG video signal 210 is transmitted over the Internet 10 to the gateway 100 of the present invention. In a preferred embodiment, the gateway 100 is aware of the presence of the commerce data stream 212 in the MPEG signal 210, but does not alter the MPEG stream 210 in any way. Rather, the gateway 100 transmits the signal 210 to television 182 without altering its content 212, 214.

As discussed above, television 182 will likely receive the signal 210 from gateway 182 through an adapter, such as adapter 230 shown in FIG. 3. This adapter 230 is specially configured to receive signals from the gateway 100 and present the received signals to the television 182. Consequently, the adapter 230 must have a receiver 232 configured to receive the signals 210 from the gateway 100. In the preferred embodiment, the receiver 232 and the gateway 100 both use the Sarnoff G2 wireless protocol to receive and send wireless LAN signals.

Although not shown in FIG. 3, it is necessary for the adapter 230 to decrypt the signal 210 received from gateway 100. As mentioned above, gateway 100 encrypts all messages to appliances 180-188 before the messages are transmitted. Thus, each adapter 230 must include an ability to decrypt the messages. This decryption ability can be included in the receiver portion 232 of adapter 230. Since the receiver 232 will also likely act as a transmitter to send signals concerning the television 182 to the gateway 100, the receiver 232 should also have the ability to encrypt signals. Of course, it would be well within the scope of the invention to omit encryption capabilities in the adapter 230.

In addition to the receiver 232, the adapter 230 also contains a decoder 234 to decode the commerce data stream 212 and the main data stream 214 found in signal 210 back into the video source 222 and the commercial message 224. These two components 222 and 224 are then presented to the television 182 through presentation logic 236. The presentation logic 236 contains the converters necessary to present the data 222, 224 into a format acceptable to television 182.

In addition, the presentation logic 236 also determines how the commercial message 224 is presented to the television 182 during the viewing of the video source material 222. In the television context, possible options include a commercial interruption in which the video source material 222 is queued and interrupted by the commercial message 224, much like commercial broadcast television. Other options include a picture-in-picture presentation of the commercial message 224, a dedicated commercial area in the television picture (such as a strip on the bottom of the screen), a translucent image that allows some of the video source material 222 to be seen through the image, or even a pop-up window such as those used on web sites. In the preferred embodiment, each of these options coexist, with the commercial message 224 itself containing instructions on how the message 224 should be presented to the appliance 180-188.

The adapter 230 must also include the ability to accept user control input and to transmit such user control commands to the gateway 100, which is accomplished by user control 238. There are numerous physical methods that can be used to allow user control commands to be inputted into the adapter 230, including infrared and radio frequency remote controls, keyboards, mice, onscreen commands, and touch-screen pads. The adapter 230 can include one or more of these physical methods within user control 238 itself, or the adapter 230 can simply accept commands that were entered into the television 182 (or whatever appliance 180-188 is attached to the adapter 230).

Finally, the preferred embodiment of adapter 230 also includes a cache 240 that can be used to cache video source material 222, commercial message 224, or even signals to and from user control 238. The cache 240 can be used for a variety of purposes, such as storing commercial message information 224 so that a complete message can be accumulated before being delivered to the television 182. In this way, a cache 240 can make up for bandwidth limitations in the commerce data stream 212. The cache 24 can also hold a commercial message 224 while the presentation logic 236 is awaiting a timing signal that indicates the message 224 should be presented. Similarly, the cache 240 could be used for video source material 222 while the commercial message 224 is presented to television 182.

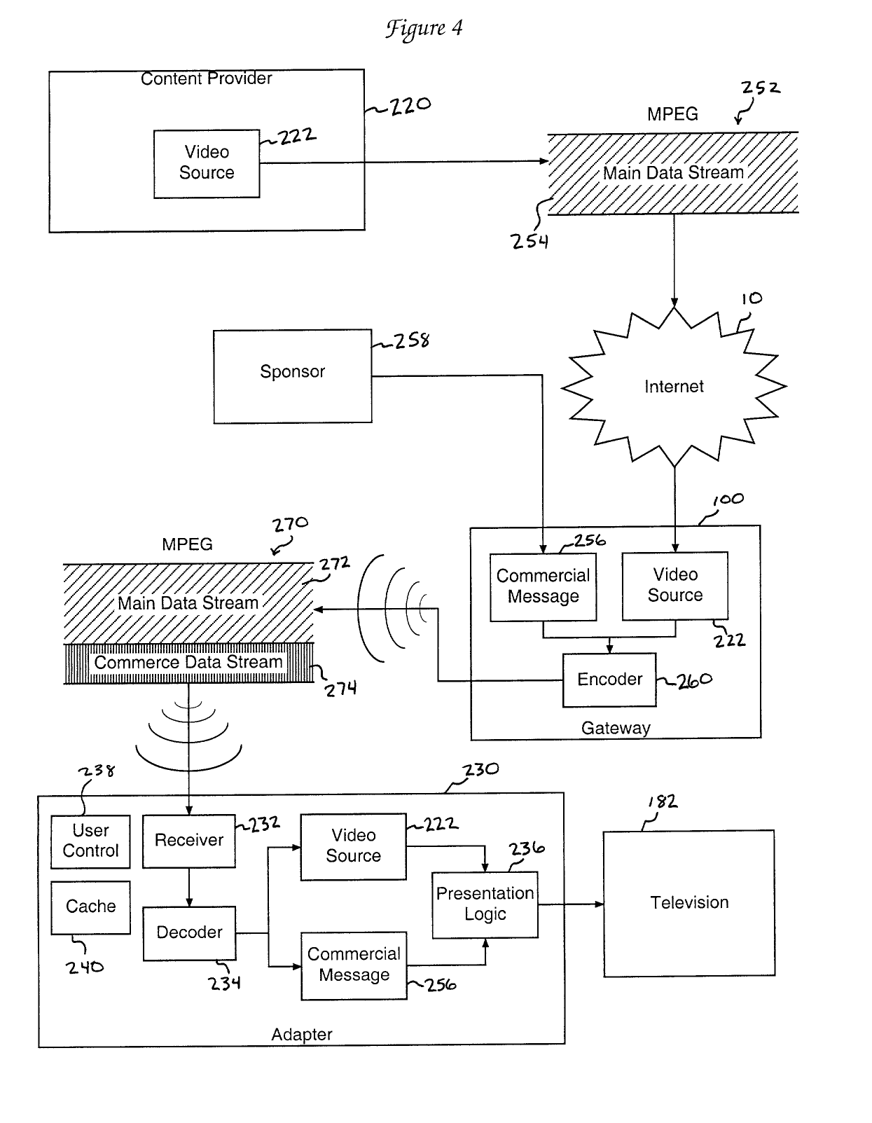

An alternative embodiment of the present invention is shown in the network configuration 250 of FIG. 4. In this Figure, the content provider 220 provides the video source material 222 without any commercial messages. Instead, the video source material 222 is sent over the Internet 10 using a standard MPEG-2 video stream 252 having only a main data stream 254.

This MPEG-2 video stream 252 is then received by the gateway 100, and is decoded back into the video source material 222. The gateway 100 then combines the source material 222 with a commercial message 256 that was provided to the gateway 100 by a sponsor 258. The sponsor 258 may be the content provider 220 itself, or may be an organization affiliated with the content provider 220. Alternatively, the sponsor 258 might not be associated with the content provider 220 in any way.

Regardless of the affiliation, the sponsor 258 has provided the gateway 100 with a commercial message 256 to be combined with the video source material 222. The commercial message 256 could be transmitted to the gateway 100 through the Internet 10, or through some other communications media such as a simple telephone connection or wireless transmission. The commercial message 256 could also be permanently stored on the storage device 150 of the gateway 100, or be provided to the gateway 100 through some removable media. Finally, rather than using one of the above methods to provide the complete content of the commercial message 256 to the gateway 100, the sponsor 258 could have used one of these methods to merely indicate how the gateway 100 should obtain the message 256. This could be accomplished simply by providing the gateway 100 with an Internet address for the desired message 256.

The gateway 100 then combines the video source material 222 and the commercial message 256 using an encoder 260 similar to the encoder 226 used by the content provider 220 shown in FIG. 3. The result of this encoding process is an MPEG-2 data stream 270 that is transmitted to the adapter 230 using the wireless LAN protocol of the gateway 100. This transmitted data stream 270 now contains the video source material 222 in the main data stream 272 (which is the same as the main data stream 254 of MPEG stream 252), and the commercial message 256 in the commerce data stream 274. The adapter 230 then uses the same techniques described above in connection with FIG. 3 to present television 182 the video source 222 and the commercial message 256.

Although the MPEG-2 video streams 210, 252, 262 are primarily designed to encode audio/video data, it is possible to encode any type of data into such a video stream 210, 252, 262. The present invention gateway 100 takes advantage of this fact by encoding all wireless communication between itself and the appliances 180-188 in MPEG-2 streams, even if the appliances 180-188 are not expecting video data. Since all wireless data transmitted from the gateway 100 is transmitted in the form of MPEG-2 streams, it is always possible to use the Sarnoff data burying technique to create a hidden commerce data stream 212, 274 in the communications to the appliances 180-188.

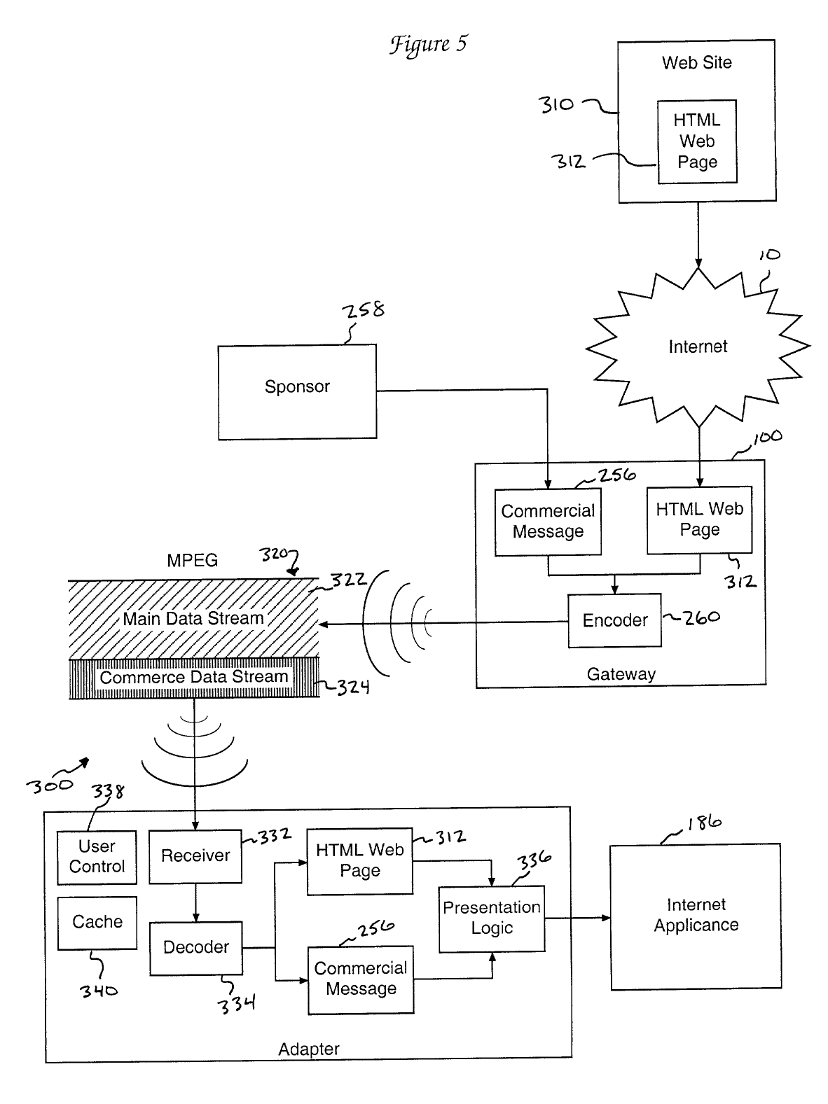

This ability is utilized in the network configuration 300 shown in FIG. 5. In this Figure, an Internet appliance 186 is being used to browse a web site 310 over the Internet 10. The html web page 312 currently being browsed is submitted to the gateway 100 over the Internet 10, and is received intact at the gateway 100.

The sponsor 258 who wishes to present a commercial message 256 to the Internet appliance 186 ensures that the gateway 100 has access to such message 256. The gateway then uses its encoder 260 to combine the HTML web page 312 and the commercial message 256 into a new MPEG-2 data stream 320. In this way, the non-video HTML traffic containing web page 312 is transmitted to the Internet appliance 186 in the main data stream 322 of the MPEG-2 stream 320, while the commercial message 256 is transmitted in the commerce data stream 324.

The Internet appliance 186 receives the data stream 320 from the gateway 100 via an adapter 330. The adapter 330 receives the data stream 320 through receiver 332. The received data stream 320 is then decoded in decoder 334 into the original HTML web page data 312 and the commercial message 256 prepared by the sponsor 258.

Up until this point, the adapter 330 is much like the adapter 230 used for television 182. Both adapters 230, 330 have a receiver 232, 332 and a decoder 234, 334, to convert the main data streams 272, 322 and the commerce data streams 274, 324 back into their original elements. In addition, both adapters 230, 330 have a user control component 238, 338, and a memory cache 240, 340. However, the presentation logic 336 in the Internet appliance adapter 330 is much different than the presentation logic 236 of adapter 230. That adapter 230 needed to present electronic data to a television 182, and therefore included the converters necessary for the television 182 to display the data presented by the adapter 230. In contrast, the presentation logic 336 of adapter 330 must present data to the Internet appliance 186. Hence, presentation logic 336 will present data in HTML format, and perhaps Java and any other format accepted by the Internet appliance 186.

In addition, presentation logic 336 must determine how the commercial message 256 is presented to the Internet appliance 186. For instance, the message 256 could be presented through a banner-like ad permanently attached to a section of the screen on the Internet appliance 186. The message 256 could alternatively be presented as a pop-up advertising window, an audio message, or even a streamed video advertisement running in the same or a separate window as the HTML page 312. Other possibilities exist for presenting the commercial message 256 with web page 312, and the present invention is not to be limited to any particular method. It is preferable to have the presentation logic 336 be capable of performing all known ways of combining the message 256 and web data 312 based upon instructions contained within the commercial message 256 itself. The sponsor 258 who developed the message 256 could then make the ultimate decision as to the method used for a particular message 256.

It would be possible for the web site 310 to provide the HTML web page data 312 already embedded into an MPEG data stream with a concurrent commerce data stream, much like was shown in FIG. 3. However, unlike the situation in FIG. 3 where the data was video source 222 that is normally expected to be transmitted over the Internet in an MPEG data stream, basic HTML data is not normally expected in MPEG format. Thus, if the web site 310 did embed the HTML web page 312 in an MPEG stream, the web site 310 must be certain that the end user is utilizing the present invention and can decode out the HTML data and the commerce channel. If the end user were not using the present invention, the embedded HTML data 312 would not be recognized within the MPEG data stream.

The above description shows that the present invention allows for a commercial message 224, 256 to be directly linked to certain desired data that is downloaded from the Internet. The content provider 220 can add the commercial message 224, 256 before placing the data on the Internet 10, as shown in FIG. 3. Alternatively, the gateway 100 within the home can combine the commercial message 224, 256 with the desired data, as shown in FIGS. 4 and 5. The desired data can take the form of video source materials 222 (FIGS. 3 and 4), or can take the form of any other type digital data, such as the HTML web page of FIG. 5. The commercial message 224, 256 is displayed on the appliance 180-188 according to the abilities of the appliance 180-188 and the instructions placed in the commercial message 224, 256. Clearly, the present invention provides a new methodology for attaching commercial messages 224, 256 to digitally downloaded data from the Internet.

Using the Commercial Data Stream to Subsidize Hardware

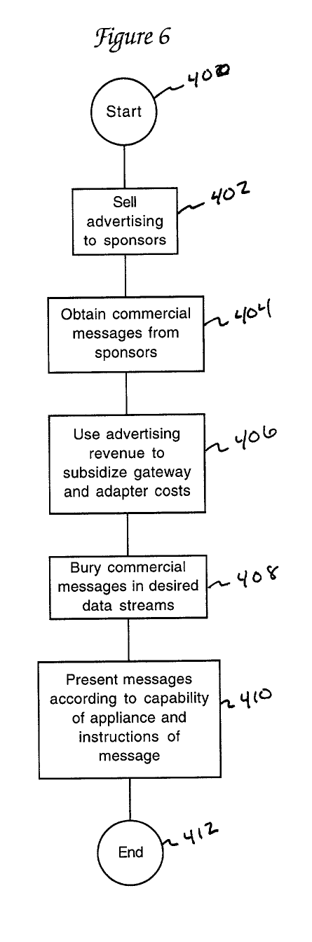

Another aspect of the present invention takes advantage of this new methodology of advertising on the Internet by obtaining revenue from advertisers and using such revenue to subsidize the cost of the gateway 100 and the adapters 230, 330. FIG. 6 shows such a methodology 400.

The first actual step 402 in methodology 400 is to sell advertising to sponsors 258. Once advertising is sold, the sponsors 258 provide commercial messages 224, 256 that are to be used with the present invention (step 404).

The advertising revenue obtained from step 402 is then used to discount the cost of the gateway 100 and the related adapters 230, 330 (step 406). It is estimated that with the use of advertising revenue generated through the use of the commerce data stream 212, 274, 324, the cost of the gateway 100 can be made directly competitive with Bluetooth 802.11(b) wireless base stations having less than one hundredth of the bandwidth of gateway 100. Of course, it may be necessary to discount the cost of the gateway 100 and related adapters 230, 330 before any advertising revenue is generated in step 402, simply in order to increase the base of gateways 100 in use.

Once a user has a gateway 100 and the required adapters 230, 330, the commercial messages 224, 256 are then buried in the desired data streams in step 408. The details of this step 408 are described above. The buried commercial messages 224, 256 are then presented to the end user according to the capability of the appliance 180-188 being used by the end user, and according to the instructions in the commercial message 224, 256 itself. (step 410). The methodology then ends at step 412.

The present invention is not to be taken as limited to all of the details described above, as modifications and variations to the invention may be made without departing from the spirit or scope of the invention. For instance, the above description refers to accessing data over the Internet. Clearly, the present invention would be equally applicable to data obtained over any network, whether private or public. In addition, although the invention preferably uses the G2 wireless technology from Sarnoff Corporation and the Sarnoff data burying techniques, other technology and techniques could be utilized without departing from the scope of the present invention. Also, although the adapters 230, 330 were discussed only in connection with a television 182 and an Internet appliance 186, it is an expected part of the present invention to develop adapters for the other appliances shown in FIG. 2, in addition to the numerous appliance not shown in the Figures, whether currently known or not. Finally, although the above discussion described wireless networks in a “house,” “home,” or “household,” the present invention is equally applicable in offices, warehouses, factories, airports, hotels, plazas, city parks, or any other location where sponsors would be interested in sending commercial messages to end users downloading digital data over a network.

What is claimed is:

1. A method of presenting a commercial message with a desired digital signal comprising:
a) combining the commercial message with the desired digital signal into a combined data stream;
b) transmitting the combined data stream over a wireless network;
c) receiving the combined data stream from the wireless network;
d) decoding the combined data stream into the commercial message and the desired digital signal; and
e) presenting the desired digital signal and the commercial message to an end user according to the capabilities of an appliance used by the end user to perceive the digital signal.

2. The method of claim 1, wherein the wireless network is a local area network.

3. The method of claim 2, further comprising the step of transmitting the combined data stream over a wide area network before transmitting the combined data stream over the wireless local area network.

4. The method of claim 3, wherein the wide area network is the Internet.

5. The method of claim 2, wherein the step of receiving the combined data stream from the wireless network and the step of decoding the combined signal are both accomplished by the appliance.

6. The method of claim 2, wherein the step of receiving the combined data stream from the wireless network and the step of decoding the combined signal are both accomplished by an adapter physically connected to the appliance.

7. The method of claim 2, wherein the presenting of the commercial message is accomplished via the appliance.

8. The method of claim 7, wherein the presenting of the commercial message is accomplished using a technique chosen from the following set: a visual presentation in a pop-up window presented in a display screen of the appliance; a visual presentation in an area comprising less than all of the display screen, with such area being dedicated to the presentation of the commercial message; a visual presentation in all of the display screen that temporarily interrupts the presenting of the desired digital signal; an audio message; or a translucent image on the display screen that allows some of the content of the desired digital signal to be seen through the translucent image.

9. The method of claim 8, wherein the technique used to present the commercial message is determined by the content of the commercial message.

10. The method of claim 3, wherein the commercial message is buried in the combined data stream, such that the commercial message is not easily detected in the combined data stream.

11. The method of claim 10, wherein the combined data stream is a functional replacement to the desired digital signal, such that a second user expecting only the desired digital signal could received the combined data stream without effecting the ability of the second user to use the combined data stream as if it were the desired digital signal.

12. The method of claim 11, wherein the combined data stream is transmitted over the wide area network in the preferred format of the desired digital signal.

13. The method of claim 12, wherein the desired digital signal is an audio/video signal and the preferred format of the desired digital signal is an MPEG-like bitstream.

14. The method of claim 13, wherein the MPEG-like bitstream is a MPEG-2 bitstream.

15. The method of claim 14, wherein the wide area network is the Internet, and wherein the end user requests the desired audio/visual signal from a content provider via the Internet.

16. The method of claim 2, further comprising the step of transmitting the desired digital signal over a wide area network before combining the desired digital signal with the commercial message.

17. The method of claim 16, wherein the wide area network is the Internet.

18. The method of claim 16, further comprising the step of receiving the commercial message from a sponsor before combining the commercial message with the desired digital signal.

19. The method of claim 18, wherein the commercial message is received from the sponsor via the wide area network.

20. The method of claim 18, wherein the sponsor communicates the location of the commercial message on the wide area network.

21. A wireless network for transmitting a commercial message with a desired digital signal to an appliance comprising:
a) a gateway having
i) a connection for receiving the desired digital signal,
ii) a storage device for storing the commercial message,
iii) an encoder that combines the commercial message and the desired digital signal into a combined data stream, and
iv) a wireless transmitter for broadcasting the combined data stream; and
b) a receiving apparatus having
i) a wireless receiver for receiving the combined data stream,
ii) a decoder that decodes the combined data stream into the desired digital signal and the commercial message, and
iii) a presentation logic device that presents the desired digital signal and the commercial message to the appliance in a format appropriate for the appliance.

22. The network of claim 21, wherein all of the gateway components are completely enclosed within a physical container.

23. The network of claim 21, wherein the receiving apparatus in enclosed with the physical confines of the appliance.

24. The network of claim 21, wherein the receiving apparatus is in an adapter container physically connected to the appliance.

25. The network of claim 21, wherein the connection is a wide area network connection.

26. The network of claim 22, wherein the wide area network connection is a broadband Internet connection.

27. The network of claim 26, wherein the storage device is in communication with the connection and further wherein the commercial message is downloaded from the Internet and temporarily stored in the storage device.

28. The network of claim 21, wherein the gateway further comprises a tuner for receiving a television channel, and wherein the television channel is presented to the connection as the desired digital signal.

29. The network of claim 28, wherein the television channel is received by the tuner digitally.

30. The network of claim 28, wherein the television channel is received by the tuner in an analog format and is digitized before being presented to the connection.

31. The network of claim 28, further comprising a wide area network interface capable of presenting data received from the wide area network to the connection as the desired digital signal.

32. The network of claim 28, wherein the appliance is a television set.

33. The network of claim 21, wherein the encoder buries the commercial message in the combined data stream such that the commercial message is not easily detected in the combined data stream.

34. The network of claim 33, wherein the gateway is able to detect whether the desired digital signal received by the connection already contains a preexisting buried commercial message; and further wherein the gateway broadcasts the desired digital signal without alteration when the preexisting buried commercial message is detected.

35. The network of claim 34, wherein the combined data stream is an MPEG-like bitstream.

36. The network of claim 21, wherein the wireless transmitter utilizes a series of broadband channels, with each channel having at least a 20 Mbps bandwidth.

37. The network of claim 36, wherein the gateway and the receiving apparatus have the ability to negotiate with each other for a clear channel.

38. An adapter for receiving a commercial message and a desired digital signal in a combined data stream and presenting the commercial message and desired digital signal to an appliance, the adapter comprising:
a) a receiver that receives the combined data stream over a wireless network;
b) a decoder in communication with the receiver that decodes the combined data stream into the commercial message and the desired digital signal; and
c) a presentation logic component in communication with the decoder, the presentation logic component having a converter to convert the commercial message and the desired digital signal into a format acceptable to the appliance.

39. The adapter of claim 38, wherein the format acceptable to the appliance is a format chosen from the set including: a digital television signal format, an analog television signal format; an digital audio format; an analog stereo audio format; an MPEG-2 bitstream; and a World Wide Web browser format.

40. The adapter of claim 38, wherein the presentation logic presents the commercial message and the desired digital signal to the appliance such that the commercial message and the desired digital signal are perceptible to an end user at the same time.

41. The adapter of claim 38, wherein the presentation logic sequentially presents the commercial message and the desired digital signal to the appliance, such that the desired digital signal is interrupted by the commercial message.

42. The adapter of claim 38, further comprising:
d) a user control component to allow the user to control selection of the desired digital signal by directing the control component to create a control signal; and
e) a transmitter that transmits the control signal over the wireless network.

43. The adapter of claim 38, further comprising a memory cache in communication with the decoder and the presentation logic component, the memory cache being capable of storing either or both of the desired digital signal and the commercial message.

44. The adapter of claim 43, wherein the message or signal in the cache is stored until the presentation logic chooses to present the stored message or signal to the appliance.

45. The adapter of claim 43, wherein the message or signal in the cache is accumulated over time until the entire message or signal has been received by the receiver.

46. The adapter of claim 38, further comprising an appliance enclosure that encloses all the elements of the adapter within the same enclosure as the appliance.
